(19) United States
(12) Patent Application Publication
(10) Pub. No.: US 2022/0204316 A1
(43) Pub. Date: Jun. 30, 2022

(54) MAINTENANCE METHOD FOR A LIFT SYSTEM, WHICH VERIFIES MAINTENANCE STEPS

(71) Applicant: TK Elevator Innovation and Operations GmbH, Duesseldorf (DE)

(72) Inventors: Daniel Bauer, Durlangen (DE); Matthias Glueck, Hochdorf (DE)

(73) Assignee: TK Elevator Innovation and Operations GmbH, Duesseldorf (DE)

(21) Appl. No.: 17/310,869

(22) PCT Filed: Feb. 18, 2020
(86) PCT No.: PCT/EP2020/054134

§ 371 Date: Mar. 10, 2022

(30) Foreign Application Priority Data
Feb. 28, 2019 (DE) 10 2019 202 675.3

(51) Int. Cl. B66B 5/00

(52) U.S. Cl. CPC B66B 5/0087; B66B 5/0025

(57) ABSTRACT

A method for maintaining an elevator installation includes performing at least one maintenance step that includes interacting with an elevator control of the elevator installation. The method further comprises confirming by the elevator control a performance of the maintenance step based on the at least one interaction. An elevator control for an elevator installation includes at least one maintenance step and an interaction signature associated with the maintenance step stored therein. An elevator installation includes an elevator control having at least one maintenance step and an interaction signature associated with the maintenance step stored therein.

The invention relates to a method for maintaining an elevator installation, a specially designed elevator control to support the maintenance method, and an elevator installation having an elevator control of this type.

Elevator installations are highly complex technical installations which are in operation for a relatively long time. Usage periods of several decades are not uncommon. Regular maintenance work needs to be carried out on different components in order to simultaneously guarantee safety. A maintenance plan is normally produced by the elevator manufacturer for this purpose, specifying precisely which work is to be carried out by the service technician. In practice, however, it has become evident that not all service technicians carry out the specified maintenance work. It thus occurs that the work specified by the elevator manufacturer is indicated as completed in the maintenance plan, but in reality has not been carried out. Different measures have already been tested in order to prevent this. QR codes, for example, have thus been affixed to the locations of the elevator installation to be inspected. The QR code should then be scanned by the service technician as a control measure following the respective maintenance step in order to prove that the service technician has actually visited the location to be inspected. Here also, however, it has also become evident that this control can be avoided. It has been observed, for example, that copies of the QR codes have been made and stored in folders. It has thus been possible for the service technician to produce a scan of the QR code without having visited the location to be inspected.

The object of the present invention is therefore to provide a deception-proof maintenance method.

This object is achieved by a method for maintaining an elevator installation having an elevator control, comprising at least one maintenance step, wherein the maintenance step comprises at least one interaction with the elevator control. The elevator control confirms a performance of the maintenance step on the basis of the at least one interaction.

A maintenance step within the meaning of this application is a functional check on a component of an elevator installation. This can be performed, for example, by means of a visual inspection of the component. Alternatively or additionally, the functional check can also be performed through a controlled use of the component under suitable test conditions.

In the maintenance method according to the invention, the elevator control provided by the elevator manufacturer therefore serves as a control instance to determine whether the intended maintenance step has been performed.

In one preferred embodiment variant, the elevator control receives incoming signals and compares them with at least one stored interaction signature. In the event of a positive identification of the interaction signature, the elevator control performs the confirmation of the maintenance step. The incoming signals are caused, in particular, by the interaction.

An interaction signature is understood within the meaning of this application to mean an input which arrives in the elevator control and is characteristic of a special procedure. The interaction signature may, for example, be a special sensor signal which arrives on a specific input channel, or a specific sequence of special sensor signals. A special input by pressing a button, or a predefined file transfer is similarly conceivable.

By comparing the incoming signals with the at least one stored interaction signature, it can be guaranteed that the associated maintenance step has actually been performed. The performance of this maintenance step can thus be reliably verified. A maintenance plan, in particular, which comprises a plurality of maintenance steps in each case having an associated interaction signature is stored in the elevator control for the comparison.

In a further variant, the elevator control has an operating mode and a maintenance mode. The comparison of the incoming signals with the at least one stored interaction signature is then performed in maintenance mode only. In particular, the maintenance method then comprises performing the detailed step of switching the elevator control to maintenance mode. Since the comparison is performed in maintenance mode only, the computing load of the elevator control is thereby reduced. Furthermore, there is a reduced risk of misidentifications which can occur if signals to the elevator control which correspond to a stored interaction signature occur randomly in the normal operation of the elevator installation.

In particular, the method is developed in such a way that it comprises a plurality of maintenance steps which are to be carried out according to a predefined maintenance pattern. Each of the maintenance steps from the plurality of maintenance steps comprises at least one interaction with the elevator control. On the basis of this at least one interaction per maintenance step, the elevator control confirms a performance of the maintenance steps and confirms the adherence to the maintenance pattern.

A maintenance pattern within the meaning of this application is understood to mean a set of maintenance steps having a defined correlation. The correlation may, for example, be a defined sequence of all maintenance steps or a subset of maintenance steps. The correlation can further comprise predefined time intervals between maintenance steps from the plurality of maintenance steps. In particular, the maintenance pattern can comprise a temporal sequence of the maintenance steps.

In particular, the method is developed in such a way that the elevator control receives incoming signals and compares them with stored interaction signatures, resulting in a sequence of positively identified interaction signatures. The elevator control then compares the sequence of positively identified interaction signatures with the maintenance pattern which is preferably stored in the elevator control. In the event of a positive identification of the maintenance pattern, the elevator control performs a confirmation of the maintenance pattern.

In particular, the maintenance pattern comprises at least one of the following characteristics:
predefined sequence of a group of maintenance steps from the plurality of maintenance steps;
predefined time intervals between two maintenance steps from the plurality of maintenance steps.

The additional checking of the maintenance pattern makes it possible to verify, for example, that the maintenance steps have been performed in the intended sequence. In the case where the maintenance pattern comprises predefined time intervals between maintenance steps, the plausibility of the entire maintenance process can furthermore be additionally checked. If, for example, a first maintenance step requires the presence of the service technician at a first location of the elevator installation (for example the elevator shaft pit) and a subsequent maintenance step requires the presence of the service technician at a second location of the elevator installation (for example the machine room), the maintenance pattern advantageously comprises a minimum time interval between these two maintenance steps. This minimum time interval is defined by the time which the service technician at least requires to move from the first location of the elevator installation to the second location of the elevator installation. The elevator control therefore checks whether the temporal sequence of the maintenance steps is realistically possible. This additionally further hinders deception during the performance of the maintenance.

In one development of the aforementioned methods, the at least one interaction with the elevator control comprises producing image information relating to the surrounding area of the service technician and the transmission of said image information to the elevator control. The image information can consist, for example, of component photos. Other variants are image videos or the use of an augmented reality device (e.g. a HoloLens). In the case of an augmented reality device, the image information of the surrounding area is analyzed and supplemented with computer-generated information. An overlaid image of both information elements is then displayed to the user.

The actual presence of the service technician at the corresponding component is verified by means of the image information. In particular, the method can further comprise an image recognition in which a check is carried out to determine whether the image information actually shows the sought component. The date and time stamp of the image information can further be read in order to check whether currently produced recordings are involved. Possible deception is further hindered as a result.

If an augmented reality device (e.g. a HoloLens) is used, the processing of the image information is preferably already carried out in the augmented reality device. This comprises, in particular, the image recognition. The augmented reality device does not therefore transmit the originally recorded image to the elevator control, but instead the information indicating that a specific component has been correctly recognized. The processing can obviously already be carried out in the mobile device (e.g. camera, smartphone, tablet, etc.) in the other cases (component photos, component videos) also, and only the result can be transmitted to the elevator control. This is also understood as image information within the meaning of this application.

In cases where the image processing is performed in the mobile device, not only the result, but additionally a verification signal (e.g. a hash code) are preferably transmitted to the elevator control. It is thereby prevented that the data transmitted to the elevator control are generated by the correct software and are not manipulated.

In one development of the aforementioned methods, the at least one interaction with the elevator control comprises performing a test run monitored by the elevator control, the opening of a door monitored by the elevator control of the performance of a brake test monitored by the elevator control. These interactions with the elevator control offer the advantage that the elevator control is involved in any case in a test run. No additional signal to the elevator control is required. The service technician instigates a test run, for example, by means of an input signal to the elevator control. The elevator control then performs the test run on the one hand in order to ensure the correct functioning of the elevator installation, and simultaneously confirms that the test run has been performed. Other maintenance steps which are likewise instigated by the elevator control are verified in a similar manner. These maintenance steps comprise, for example, performing a brake test monitored by the elevator control or performing a functional check monitored by the elevator control on at least one door, for example a shaft door or elevator car door.

In one development of the aforementioned methods, the at least one interaction with the elevator control comprises removing a visual restriction monitored by the elevator control. A maintenance step comprises, for example, the visual inspection of the shaft pit. At least one shaft door must be manually opened or an automatic door opening must be instigated in order to perform this maintenance step. In both cases, the elevator control receives a signal indicating that the shaft door has been opened. This signal can be used by the elevator control to confirm this maintenance step. Other visual restrictions, such as machine housings, control cabinet doors, brake covers, access doors to the machine room or shaft pit, or similar visual restrictions can also be monitored accordingly by the elevator control by means of sensors so that a sensor signal to the elevator control is generated when a corresponding visual restriction is removed. This sensor signal can then be used by the elevator control to confirm this maintenance step.

In one development of the aforementioned methods, the at least one interaction with the elevator control comprises actuating a service button connected to the elevator control. The actuation of the service button serves to verify the presence of the service technician at a specific location of the elevator installation. In this way, it can be ensured that the service technician has actually visited the component to be maintained.

In particular, the aforementioned methods are developed in such a way that the confirmation of the maintenance step or the confirmation of the maintenance pattern by the elevator control comprises at least one of the following steps:
recording a confirmation entry in a maintenance log of the elevator control;
transmitting a confirmation signal to a remote system;
transmitting a confirmation signal to a connectable maintenance control.

The recording of a confirmation entry in a maintenance log file of the elevator control offers the advantage that all information relating to the maintenance history collected at the location of the elevator installation is automatically available and can be displayed on demand.

The transmission of a confirmation signal to a remote system offers the advantage that information relating to a multiplicity of elevator installations can be collected in bundled form at one location. The remote system can, for example, be a central service center from which a large number of elevator installations and service technicians are monitored. The remote system can similarly be a data memory connected to the Internet (cloud). This enables a better evaluation of the collected information relating to the maintenance procedures of a large number of elevator installations.

The connectable maintenance control is, in particular, a handheld device or tablet computer which is carried by the service technician for maintenance purposes. The connection to the elevator control can be established, for example, via cable, but also wirelessly via Bluetooth, WLAN, mobile radiocommunication or a different known wireless transmission type. The transmission of a confirmation signal to a maintenance control of this type offers the advantage that the service technician already receives a verified confirmation of the maintenance in situ on the device that he is carrying with him.

The invention similarly relates to an elevator control for an elevator installation, wherein a maintenance plan comprising at least one maintenance step and an interaction signature associated with the maintenance step is stored in the elevator control. The elevator control is designed to compare incoming signals with the interaction signature and, in the event of a positive identification of the interaction signature, to perform a confirmation of the associated maintenance step.

The elevator control comprises, in particular, an operating mode and a maintenance mode. The elevator control further comprises a comparison module to compare incoming signals with the interaction signature, and is designed to feed the incoming signals to the comparison module in maintenance mode.

In one special development, a maintenance plan comprising a plurality of maintenance steps having a respective associated interaction signature is stored in the elevator control. The maintenance plan further comprises a maintenance pattern. The elevator control is designed to compare a sequence of positively identified interaction signatures with the maintenance pattern and, in the event of a positive identification of the maintenance pattern, to perform a confirmation of the maintenance pattern.

In one special design of the elevator control, a maintenance plan log is stored in the elevator control for recording confirmation entries. Alternatively or additionally, the elevator control comprises an interface to a remote system which is designed to transmit confirmation signals. Alternatively or additionally, the elevator control comprises an interface to a connectable maintenance control which is designed to transmit confirmation signals.

The elevator control has the same advantages as those previously described with regard to the method according to the invention.

The object according to the invention is similarly achieved by an elevator installation having a previously described elevator control.

In particular, the elevator installation comprises at least one service button which is connected to the elevator control. The elevator installation preferably comprises a plurality of service buttons which are connected to the elevator control. The at least one service button is disposed, in particular, at one of the following locations:
shaft pit of the elevator installation;
machine room of the elevator installation;
car roof of a car of the elevator installation;
surrounding area of a door drive of the elevator installation, in particular a shaft door drive or an elevator car drive;
surrounding area of a drive of the elevator installation.

The connection of the service buttons to the elevator control can be either wired or wireless.

The surrounding area of a component is understood within the meaning of this application to mean the area from which a line-of-sight connection exists between the service technician and the component.

As explained above with regard to the method according to the invention, the service buttons offer the advantage that it is possible to verify with certainty that the service technician has actually visited the corresponding area. No additional effort is also required on the part of the service technician himself. On completion of the corresponding maintenance step, only the service button disposed nearby has to be actuated in order to inform the elevator control of the completion of the maintenance step. Corresponding service buttons can further be installed at very low cost. Corresponding service buttons can also be retrofitted in a simple manner. Both the elevator control and the service buttons are then equipped, for example, with a radio module to communicate with one another. Technology of this type is also known from radio-based light switches and can be purchased at low cost.

The invention is explained in detail below with reference to the figures, wherein:

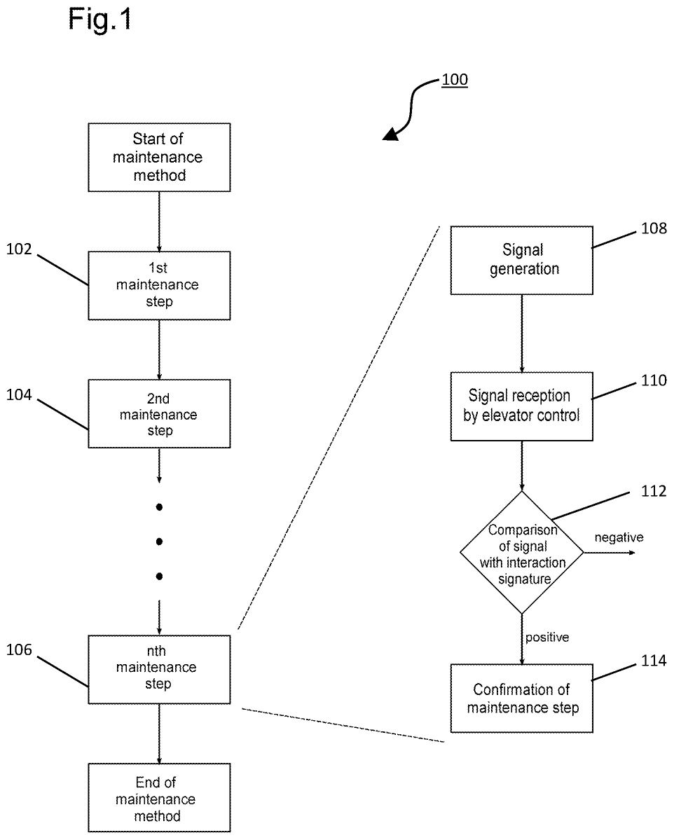

FIG. 1 shows a flow diagram of a first embodiment of the method according to the invention;

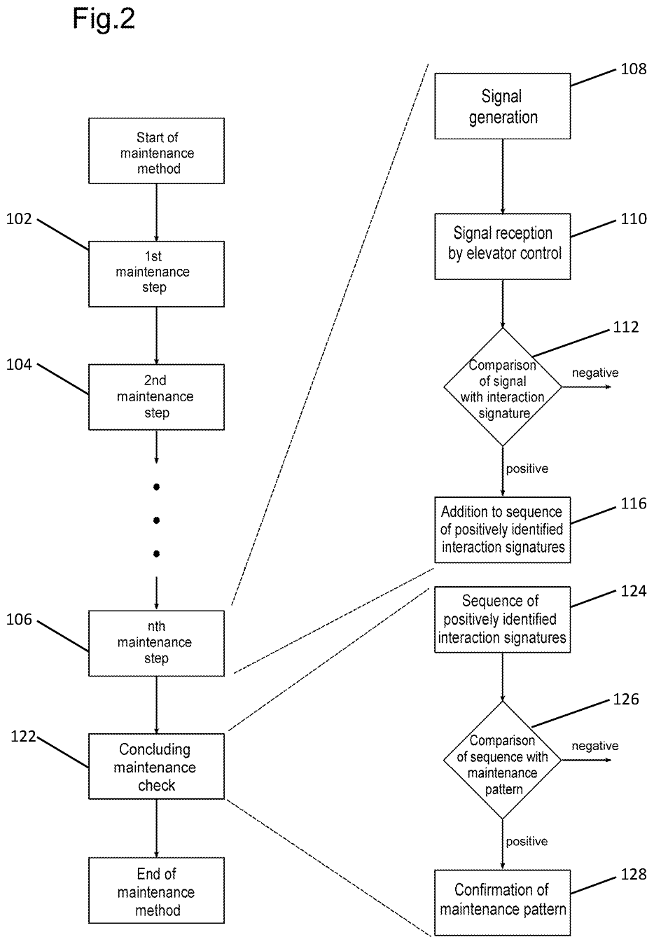

FIG. 2 shows a flow diagram of an alternative embodiment of the method according to the invention;

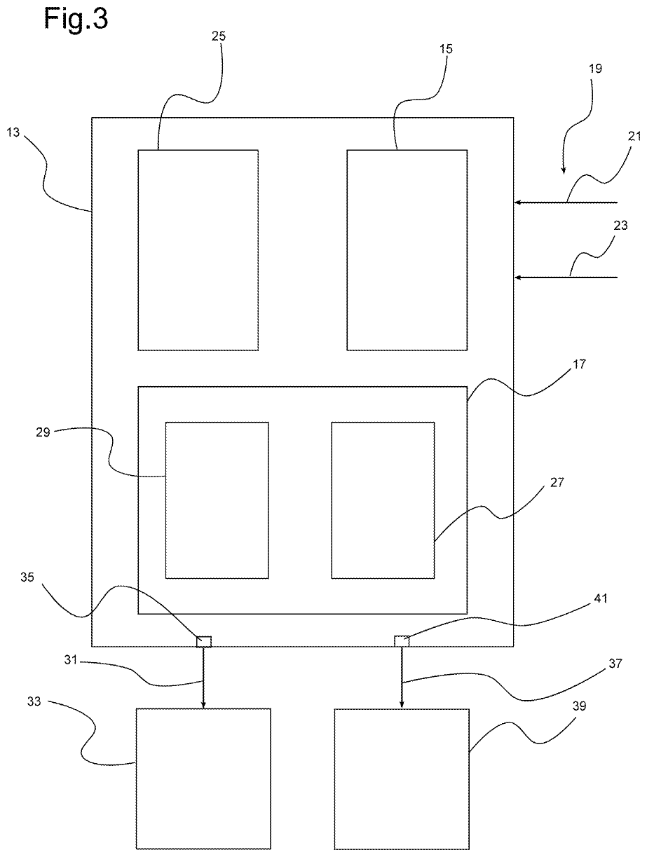

FIG. 3 shows a schematic view of an elevator control according to the invention;

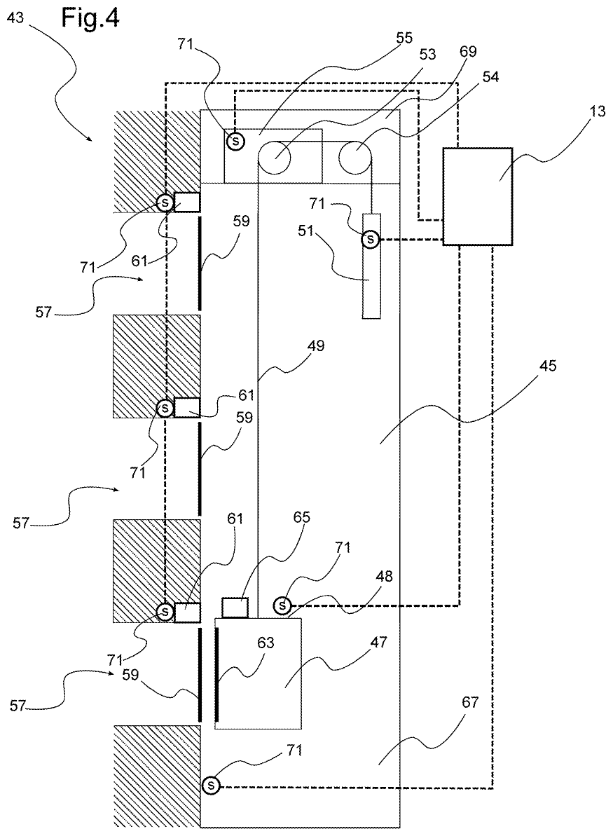

FIG. 4 shows a schematic view of an elevator installation according to the invention.

FIG. 1 shows a flow diagram of the method according to the invention for maintaining an elevator installation. The method comprises a plurality of maintenance steps which are performed successively. A sequence of maintenance steps is shown, starting with a 1st maintenance step through to an nth maintenance step (n is a positive integer greater than 1). The internal process is shown by way of example for the nth maintenance step in the right-hand part of FIG. 1. The same applies accordingly to the further maintenance steps. In each maintenance step, an interaction takes place with the elevator control in which a signal to the elevator control is generated. This signal is received by the elevator control and is compared with a stored interaction signature. In the case of a positive identification of the interaction signature, the elevator control performs a confirmation of the maintenance step. Each maintenance step therefore ends with a confirmation, i.e. verification of the maintenance step by the elevator control.

Specifically, the maintenance steps can comprise a wide range of different activities which are also associated accordingly with different interactions and therefore also different signals to the elevator control. Two different categories of interactions can essentially be distinguished. On the one hand, these involve interactions with the elevator control which are performed exclusively for the purpose of verifying the maintenance step, and, on the other hand, interactions with the elevator control which occur in any event during the maintenance.

In one development of the aforementioned methods, the at least one interaction with the elevator control comprises producing image information relating to the surrounding area of the service engineer and the transmission of said image information to the elevator control. The image information can consist, for example, of component photos. Other variants are image videos or the use of an augmented reality device (e.g. a HoloLens). In the case of an augmented reality device, the image information of the surrounding area is analyzed and supplemented with computer-generated information. An overlaid image of both information elements is then displayed to the user.

The first category comprises, for example, the actuation of a service button connected to the elevator control. This is explained in detail below with reference to FIG. 4. The actuation of the service button merely serves to verify the presence of the service technician at a specific location of the elevator installation. In this way, it can be ensured that the service technician has actually visited the component to be maintained. A different example from this category is the creation of image information relating to the surrounding area of the service technician and the transmission of said image information to the elevator control. The image information can consist, for example, of component photos. Other variants are image videos or the use of an augmented reality device (e.g. a HoloLens). In the case of an augmented reality device, the image information of the surrounding area is analyzed and supplemented with computer-generated information. An overlaid image of both information elements is then displayed to the user. The presence of the service technician at the component to be maintained is verified in all these cases in that the service technician produces image information of the component and transmits said image information to the elevator control. The elevator control then verifies this image information in order to confirm the presence of the service technician at the component. The verification can further comprise, for example, an image recognition in which a check is carried out to determine whether the image information actually represents the sought component. The date and time stamp can further be read in order to check whether currently recorded image information is involved.

The second category of interaction with the elevator control comprises, for example, the performance of a test run monitored by the elevator control. In this case the service technician instigates a test run by means of an input signal to the elevator control. The elevator control then performs the test run on the one hand in order to ensure the correct functioning of the elevator installation, and simultaneously confirms that the test run has been performed. Other maintenance steps which are likewise instigated by the elevator control are verified in a similar manner. These maintenance steps comprise, for example, performing a brake test monitored by the elevator control or performing a functional check monitored by the elevator control on at least one door, for example a shaft door or elevator car door.

The second category similarly includes interactions with the elevator control which occur during the maintenance, even if they do not relate directly to the component to be maintained. A maintenance step comprises, for example, the visual inspection of the shaft pit. At least one shaft door must be manually opened or an automatic door opening must be instigated in order to perform this maintenance step. In both cases, the elevator control receives a signal indicating that the shaft door has been opened. This signal can be used by the elevator control to confirm this maintenance step. Other visual restrictions, such as machine housings, control cabinet doors, brake covers, access doors to the machine room or shaft pit, or similar visual restrictions can also be monitored accordingly by the elevator control by means of sensors so that a sensor signal to the elevator control is generated when a corresponding visual restriction is removed. This sensor signal can then be used by the elevator control to confirm this maintenance step.

In all cases, a signal of some sort is produced which arrives in the elevator control. This signal is received by the elevator control and is compared with a stored interaction signature. For this purpose, the elevator control comprises a maintenance plan which is stored in the elevator control. The maintenance plan comprises at least one maintenance step and an interaction signature associated with the maintenance step. In the event of a positive identification of the interaction signature, the elevator control performs a confirmation of the corresponding associated maintenance step. Information could be stored in the maintenance plan indicating, for example, that the sensor signal relating to a manual opening of the shaft door on the lowermost floor is associated with the “visual inspection of the shaft pit” maintenance step as the interaction signature of this maintenance step. If the elevator control then receives a signal, it compares this incoming signal with the stored interaction signatures in the maintenance plan. The elevator control has a comparison module for this purpose. If this comparison results in a positive identification of the signal as the sensor signal relating to a manual opening of the shaft door on the lowermost floor, the associated “visual inspection of the shaft pit” maintenance step is confirmed.

In special designs of the method according to the invention, the elevator control has an operating mode and a maintenance mode. The comparison described above of the incoming signals with the stored interaction signature is carried out in maintenance mode only. At the start of the maintenance method, the elevator control is then first switched to maintenance mode.

FIG. 2 shows a flow diagram of an alternative method for maintaining an elevator installation. The method comprises a plurality of maintenance steps which are performed successively. A sequence of maintenance steps is shown, starting with a 1st maintenance step through to an nth maintenance step (n is a positive integer greater than 1). A concluding maintenance check is carried out following the plurality of maintenance steps. The internal process is shown by way of example for the nth maintenance step in the right-hand part of FIG. 2. The same applies accordingly to the further maintenance steps. Furthermore, the internal process of the concluding maintenance check is similarly shown in the right-hand part of FIG. 2. In each maintenance step, an interaction takes place with the elevator control in which a signal to the elevator control is generated. This signal is received by the elevator control and is compared with stored interaction signatures. In the case of a positive identification, the elevator control adds this interaction signature to a sequence of positively identified interaction signatures. At the end of each maintenance step, an element is therefore added to the sequence of positively identified interaction signatures.

This sequence of positively identified interaction signatures is compared with a predefined maintenance pattern in the step of the concluding maintenance check. In the event of a positive result of this comparison, the elevator control confirms a performance of the maintenance steps associated with these interaction signatures and the adherence to the maintenance pattern.

It is explained with reference to FIGS. 2 and 3 that the elevator control performs a confirmation of the maintenance step or a confirmation of the maintenance pattern. This confirmation can be performed in different ways. A confirmation entry, for example, is recorded in a maintenance log of the elevator control. Alternatively or additionally, a confirmation signal is sent to a provided remote system. The remote system can, for example, be a central service center which monitors the maintenance procedures of a plurality of elevator installations. The remote system can similarly be a data memory connected to the Internet (cloud). A further variant for the confirmation of the maintenance step or the maintenance pattern comprises transmitting a confirmation signal to a connectable maintenance control. The connectable maintenance control is, in particular, a handheld device or tablet computer which is carried by the service technician for maintenance purposes. The connection to the elevator control can be established, for example, via cable, but also wirelessly via Bluetooth, WLAN, mobile radiocommunication or a different known wireless transmission type.

FIG. 3 shows a schematic view of an elevator control 13 according to the invention. The elevator control comprises a comparison module 15 and a control module 25. The comparison module 15 is designed to compare incoming signals 19 with one or more interaction signatures. This can be performed uninterruptedly, or only after the elevator control has been switched to a maintenance mode. The control module 25 performs the remaining functions that are required for the operation of an elevator installation. These include, for example, the coordination of calls and the control of the drive and the doors. The incoming signals can, for example, be sensor signals 21 or signals 23 from an operating terminal. The elevator control further comprises a memory area 17. A maintenance plan 27 and a maintenance log 29 are stored in the memory area 17. The maintenance plan 27 comprises at least one maintenance step and an interaction signature associated with the maintenance step. Since a maintenance operation typically comprises a plurality of maintenance steps, the maintenance plan 27 normally also contains a plurality of maintenance steps with an associated interaction signature. In addition, the maintenance plan can also comprise a maintenance pattern which specifies a specific correlation of the maintenance steps. In this case, the comparison module 15 is further designed to compare a sequence of positively identified interaction signatures with the maintenance pattern. The elevator control can consequently carry out the method explained with FIG. 2 with a concluding maintenance check. In order to perform the confirmation of the maintenance pattern or to confirm the positive identification of an interaction signature, the elevator control 13 comprises the maintenance log 29. A corresponding confirmation entry is then recorded in the maintenance log 29 as confirmation. Alternatively or additionally, the confirmation can also be performed by transmitting a confirmation signal 31 to a remote system 33. The elevator control has an interface 35 to the remote system 33 for this purpose. Alternatively or additionally, the confirmation can also be performed by transmitting a confirmation signal 37 to a connectable maintenance control 39. The elevator control has an interface 41 to the connectable maintenance control 39 for this purpose. The elevator control 13 can obviously also first generate a complete maintenance log 29 and then transmit it to a remote system 33 and/or a connectable maintenance control 39.

FIG. 4 shows a schematic view of an elevator installation 43. The elevator installation 43 comprises an elevator shaft 45 in which an elevator car 47 having an elevator car roof 48 is movably disposed. The elevator car 47 is connected via a support means 49 to a counterweight 51. The support means 49 is guided via a traction sheave 53 of a drive 55 and a deflection roller 54 so that the elevator car 47 can be moved by means of the drive 55 in the elevator shaft 45. The elevator shaft 45 has a plurality of entrances 57. The entrances 57 are fitted in each case with a shaft door 59 which is opened only when the elevator car 47 is positioned in front of the respective entrance 57. The shaft doors 59 are opened and closed by means of the shaft door drives 61. The elevator car 47 has an elevator car door 63 which is opened and closed by means of the elevator car door drive 65.

The shaft pit 67 in which further components, such as, for example, a buffer (not shown), can be disposed is located underneath the lowermost entrance 57. The machine room 69 in which the drive 55 and the deflection roller 54 are disposed is located above the uppermost entrance 57. The elevator installation 43 further comprises an elevator control 13. Along with the usual functions that are required for the operation of the elevator installation 43, the elevator control 13 is further designed to verify the maintenance of the elevator installation 43. During the correct maintenance of the elevator installation 43, the service technician goes to different locations of the elevator installation 43 in succession and inspects the components disposed there or carries out maintenance work on these components. The service technician goes, for example, onto the elevator car roof 48, into the shaft pit and the machine room. The maintenance activities can further include the removal of corresponding casings at each of the entrances 57 in order to maintain the shaft door drive 61. In order to then verify that the service technician has actually visited the corresponding locations of the elevator installation 43, the elevator installation 43 comprises a plurality of service buttons 71 which are connected to the elevator control 13. The connection to the elevator control 13 is shown by broken lines in FIG. 4. This signal collection can obviously be implemented as either wired or wireless. In the embodiment according to FIG. 4, a service button 71 is located in the shaft pit 67 of the elevator installation 43, a service button 71 is located in the machine room 69 of the elevator installation 43, a service button 71 is located on the elevator car roof 48 of the elevator car 47, and a service button 71 is located in each case in the surrounding area of each shaft door drive 61 of the elevator installation 43. The service button 71 on the elevator car roof 48 is simultaneously located in the surrounding area of the elevator car door drive 65. The service button 71 in the machine room 69 is simultaneously located in the surrounding area of the drive 55 of the elevator installation 43. This equipment of the elevator installation 43 with the service button 71 enables the service technician, after each maintenance step, to actuate a service button 71 provided for that purpose. The actuation of the service button 71 produces a signal to the elevator control 13 which then confirms a performance of this maintenance step.

The example embodiments shown in the figures and explained in connection therewith serve to explain the invention and are non-limiting for it. In particular, the views are in some instances not presented true-to-scale. The figures are not shown in great detail for the sake of greater clarity.

### REFERENCE NUMBER LIST

13 Elevator control
15 Comparison module
17 Memory area
19 Incoming signals
21 Sensor signals
23 Signals from operating terminals
25 Control module
27 Maintenance plan
29 Maintenance log
31 Confirmation signal
33 Remote system
35 Interface to the remote system
37 Confirmation signal
39 Connectable maintenance control
41 Interface to the connectable maintenance control
43 Elevator installation
45 Elevator shaft
47 Elevator car
48 Elevator car roof
49 Support means
51 Counterweight
53 Traction sheave
54 Deflection roller
55 Drive
57 Entrances
59 Shaft door
61 Shaft door drive
63 Elevator car door
65 Elevator car door drive
67 Shaft pit
69 Machine room
71 Service button

1.-15. (canceled)

16. A method for maintaining an elevator installation, comprising:
performing at least one maintenance step, which includes interacting at least once with an elevator control of the elevator installation; and
confirming, by the elevator control, performance of the at least one maintenance step based on the at least one interaction.

17. The method of claim 16, wherein:
said sub-step of interacting with the elevator control comprises receiving incoming signals into the elevator control; and
said confirming step comprises,
comparing, by the elevator control, the incoming signals with at least one stored interaction signature, and
confirming, by the elevator control, performance of the at least one maintenance step in response to a positive identification of the interaction signature being present among the incoming signals.

18. The method of claim 17, wherein the elevator control is operable in an operating mode and a maintenance mode, and wherein said step of comparing the incoming signals is performed only in the maintenance mode.

19. The method of claim 16, wherein,
said performing step comprises performing a plurality of maintenance steps to be carried out according to a predefined maintenance pattern, wherein each of the plurality of maintenance steps includes interacting at least once with the elevator control, and
said confirming step comprises confirming, by the elevator control, the performance of each of the plurality of maintenance steps and adherence to the predefined maintenance pattern, based on each interaction with the elevator control in each performed maintenance step.

20. The method of claim 19, wherein:
said sub-step of interacting at least once with the elevator control comprises receiving incoming signals into the elevator control,
said confirming step comprises,
comparing, by the elevator control, the incoming signals to a plurality of stored interaction signatures to search for a match therebetween,
positively identifying, among the incoming signals, a sequence of interaction signatures that match the stored interaction signatures,
comparing, by the elevator control, the sequence of positively identified interaction signatures to the predefined maintenance pattern, and
confirming, by the elevator control, performance of the predefined maintenance pattern in response to a positive identification that the sequence of positively identified interaction signatures matches the predefined maintenance pattern.

21. The method of claim 19, wherein the predefined maintenance pattern includes at least one of a predefined sequence of a group of maintenance steps from the plurality of maintenance steps, or predefined time intervals between two maintenance steps from the plurality of maintenance steps.

22. The method of claim 16, wherein said sub step of interacting at least once with the elevator control comprises at least one of:
actuating a service button connected to the elevator control;
producing image information and transmitting said image information to the elevator control;
performing a test run monitored by the elevator control;
performing a brake test monitored by the elevator control;
removing a visual restriction monitored by the elevator control;
opening a door monitored by the elevator control; or
performing a functional check monitored by the elevator control on at least one door.

23. The method of claim 16, wherein said step of confirming performance of the at least one maintenance step by the elevator control comprises at least one of:
recording a confirmation entry in a maintenance log;
transmitting a confirmation signal to a remote system; or
transmitting a confirmation signal to a connectable maintenance control.

24. An elevator control for an elevator installation, comprising:
a memory area in which is stored a maintenance plan, which maintenance plan includes at least one maintenance step and an interaction signature associated with the at least one maintenance step; and
a comparison module configured to compare incoming signals from performance of the at least one maintenance step with the stored interaction signature, and confirm the actual performance of the associated maintenance step in response to a positive identification that the incoming signals include the interaction signature.

25. The elevator control of claim 24, wherein the elevator control is operable in either of an operating mode or a maintenance mode, wherein the comparison module is configured to feed the incoming signals to the comparison module while in the maintenance mode.

26. The elevator control of claim 24,
wherein a maintenance plan comprising a plurality of maintenance steps and a maintenance pattern is stored in the memory area,
wherein each of the stored maintenance steps includes an associated stored interaction signature, and
wherein the comparison module is configured to:
compare a sequence of positively identified interaction signatures present in the incoming signals with the maintenance pattern, and
confirm performance of the maintenance pattern in response to the positive identification of the maintenance pattern present in the incoming signals.

27. The elevator control of claim 24, further comprising at least one of:
a maintenance log configured to record confirmation entries;
a first interface that is configured to transmit confirmation signals to a remote system; or
a second interface that is configured to transmit confirmation signals to a connectable maintenance control.

28. An elevator installation comprising:
the elevator control of claim 24; and
at least one service button connected to the elevator control.

29. The elevator installation of claim 28, wherein the at least one service button is disposed at one of the following locations:
a shaft pit of the elevator installation;
a machine room of the elevator installation;
an elevator car roof of an elevator car of the elevator installation;
a surrounding area of a door drive of the elevator installation; or
a surrounding area of a drive of the elevator installation.
